(19) United States
(12) Patent Application Publication
(10) Pub. No.: US 2015/0034255 A1
(43) Pub. Date: Feb. 5, 2015

(54) Fly screen for window air conditioner unit

(71) Applicants: Annie Lee Dendulk, Palatka, FL (US); Adriaan Dendulk, Palatka, FL (US)

(72) Inventors: Annie Lee Dendulk, Palatka, FL (US); Adriaan Dendulk, Palatka, FL (US)

(21) Appl. No.: 14/446,314

(22) Filed: Jul. 29, 2014

Related U.S. Application Data
(60) Provisional application No. 61/859,777, filed on Jul. 30, 2013.

(51) Int. Cl. E06B 9/52; B23P 19/04

(52) U.S. Cl. CPC E06B 9/52; B23P 19/04
USPC 160/38; 29/428; 29/426.1

(57) ABSTRACT

A fly screen for a window air conditioner provides an attachment providing an all-around screen around the entire edge of the opening. The all-around screen is secured tightly to all four sides of the air conditioner with an elastic seam. The all-around screen is box-shaped, and is provided in a variety of sizes to fit all window air conditioners that are commercially available.

### CROSS-REFERENCE TO RELATED APPLICATIONS

This application claims the benefit of U.S. Provisional Application No. 61/859,777, filed Jul. 30, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to window attachments and accessories and in particular to a fly screen for a window air conditioner. When a new window air conditioner is installed in the home, various attachments have been provided by the manufacturers to keep insects out. Unfortunately, they have never been completely satisfactory as flying insects always find a way into the home for a variety of reasons, often crawling under the air conditioner. An attachment featuring an all-around screen around the entire edge of the opening would resolve these problems.

### SUMMARY OF THE INVENTION

Accordingly, the invention is directed to a fly screen for a window air conditioner. The fly screen is an attachment providing an all-around screen around the entire edge of the opening. The all-around screen is secured tightly to all four sides of the air conditioner with an elastic seam. The all-around screen is box-shaped, and is provided in a variety of sizes to fit all window air conditioners that are commercially available.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate three embodiments of the invention and, together with the description, serve to explain the principles of the invention.

FIG. 1 shows a side perspective view of the first exemplary embodiment mounted on an air conditioner, displaying the all-around screen 10, the elastic seam 11, the air conditioner 12, the edge portion 13, the box portion 14, and the window opening 15.

FIG. 2 shows a side perspective view of the first exemplary embodiment prior to its mounting on an air conditioner, displaying the all-around screen 10, the elastic seam 11, the edge portion 13, and the box portion 14.

FIG. 3 shows an interior perspective view of the first exemplary embodiment prior to its mounting on an air conditioner, displaying the all-around screen 10, the elastic seam 11, the edge portion 13, and the box portion 14.

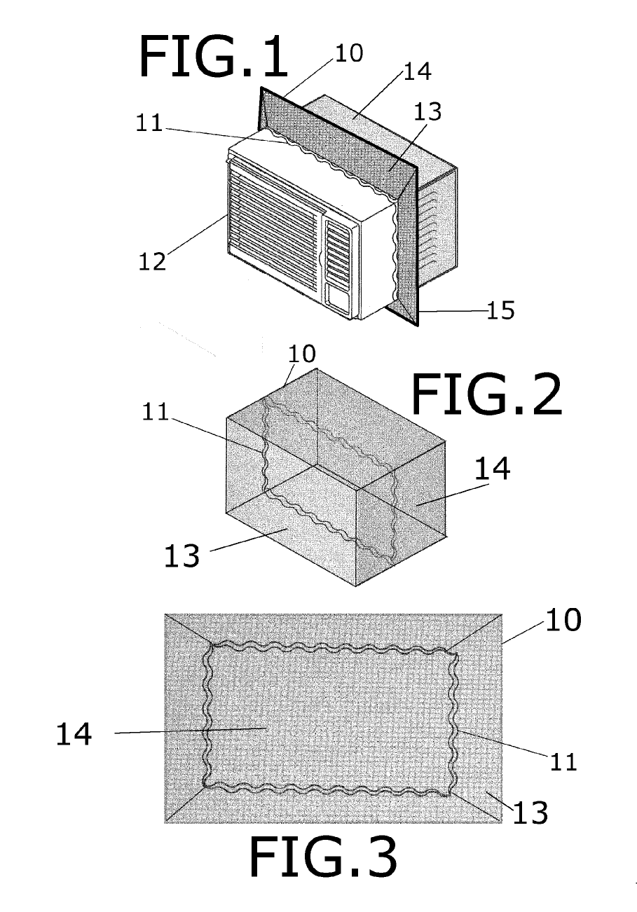

### DETAILED DESCRIPTION OF THE INVENTION

Referring now to the invention in more detail, the invention is directed to a fly screen for a window air conditioner. The fly screen is an attachment providing an all-around screen 10 around the entire edge of the window opening 15. The all-around screen 10 is secured tightly about all four sides of the air conditioner 12 with an elastic seam 11, and is removable for cleaning. The elastic seam 11 may be integrated into a monolithic all-around screen 10, thereby demarcating the edge portion 13 from the box portion 14, or alternatively the box portion 14 and the edge portion 13 may be separate pieces joined by the elastic seam 11. The outer edge portion 13 of the all-around screen 10 is affixed to the window sash or window frame (generally, the window opening 15) during installation, using peel-and-stick adhesive strips or hook-and-loop fastener strips which are provided to the user. The all-around screen 10 provides a box portion 14, and is provided in a variety of sizes to fit a wide range of window air conditioners 12 that are commercially available.

To install the fly screen, the user opens the window to a sufficient height, unfolds the all-around screen 10, and affixes the edge portion 13 to the window opening 15 using peel-and-stick adhesive strips or hook-and-loop fastener strips, which are provided. The user then fully unfolds the box portion 14 through the opening in the window, and installs the air conditioner 12 through said elastic seam 11, securing the all-around screen 10 about the air conditioner 12 using the elastic seam 11. To clean the fly screen, the user uninstalls the air conditioner 12 and removes the edge portion 13 from the window opening 15. The user then rinses it off under a hand sprayer or running water from a faucet. The device as presently envisioned is not machine-washable. The user the re-affixes the edge portion 13 to the window opening 15 and re-installs the air conditioner.

The all-around screen 10 is preferably manufactured from flexible, durable fiber materials that are easily laundered, such as cotton, a cotton-elastane blend, or a cotton-rayon blend. The elastic seam 11 is preferably manufactured from a flexible, durable fabric such as elasticized cotton. The hook and loop fastener strips are preferably manufactured from a flexible, durable material such as plastic or nylon.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

We claim:

1. A fly screen for a window air conditioner comprising a box portion; an edge portion;
an elastic seam; said elastic seam being affixed to said fly screen between said box portion and said edge portion; said box portion and said elastic seam being sized to accommodate a window air conditioner; said edge portion being sized to accommodate a window opening; said edge portion being removably affixed to said window opening.

2. The fly screen for a window air conditioner of claim 1 wherein said fly screen is made of a flexible, durable, fiber material.

3. A method of installation of the fly screen for a window air conditioner of claim 1 comprising opening said window opening to a sufficient size to accommodate said window air conditioner, affixing said edge portion to said window opening, unfolding said portion through said window opening, installing said air conditioner, and securing said elastic seam about said air conditioner.

4. A method of installation of the fly screen for a window air conditioner of claim 2 comprising opening said window opening to a sufficient size to accommodate said window air conditioner, affixing said edge portion to said window opening, unfolding said portion through said window opening, installing said window air conditioner, and securing said elastic seam about said window air conditioner.

5. A method of cleaning the fly screen for a window air conditioner of claim 1 comprising uninstalling said window air conditioner, removing said edge portion from said window opening, rinsing said fly screen under running water, re-affixing said edge portion to said window opening, and re-installing said window air conditioner.

6. A method of cleaning the fly screen for a window air conditioner of claim 2 comprising uninstalling said window air conditioner, removing said edge portion from said window opening, rinsing said fly screen under running water, re-affixing said edge portion to said window opening, and re-installing said window air conditioner.

7. A method of cleaning a fly screen for a window air conditioner comprising uninstalling said window air conditioner, removing said edge portion from said window opening, rinsing said fly screen under running water, re-affixing said edge portion to said window opening, and re-installing said window air conditioner according to the method of claim 3.

8. A method of cleaning a fly screen for a window air conditioner comprising uninstalling said window air conditioner, removing said edge portion from said window opening, rinsing said fly screen under running water, re-affixing said edge portion to said window opening, and re-installing said window air conditioner according to the method of claim 4.
